(19) United States
(12) Patent Application Publication
(10) Pub. No.: US 2011/0236720 A1
(43) Pub. Date: Sep. 29, 2011

(54) NOBLE METAL-CONTAINING LAYER SEQUENCE FOR DECORATIVE ARTICLES

(76) Inventors: Joachim Grimm, Schwaebisch Gmuend (DE); Michael Lauster, Schwaebisch Gmuend (DE); Philip Schramek, Lorch (DE)

(21) Appl. No.: 13/130,154

(22) PCT Filed: Nov. 3, 2009
(86) PCT No.: PCT/EP09/07853

§ 371 Date: May 19, 2011

(30) Foreign Application Priority Data
Nov. 21, 2008 (EP) 08020286.4

(51) Int. Cl. B32B 15/01; C25D 5/10; C23C 28/02; C25D 3/56

(52) U.S. Cl. 428/670; 205/176; 205/187

(57) ABSTRACT

The present invention is directed at a decorative article which has a particular noble metal-containing outer layer sequence. The invention further relates to a coating process suitable for this purpose. The layer sequence is characterized in that a palladium-containing bottom layer is followed by an electrolytically deposited alloy of ruthenium and an element of the group consisting of platinum and rhodium.

The present invention is directed at a decorative article which has a particular noble metal-containing outer layer sequence. The invention further relates to a coating process suitable for this purpose. The layer sequence is characterized in that a palladium-containing bottom layer is followed by an electrolytically deposited alloy of ruthenium and an element of the group consisting of platinum and rhodium.

In the production of fashion jewellery, a jewellery base body is produced from a cheap material such as brass, a copper-zinc alloy, or from pure zinc. Since both materials are very electropositive and when worn on the skin, as is usually the case for jewellery, become very unsightly after only a short time, jewellery articles made of these alloys or metals have to be “upgraded”.

The metals platinum and/or rhodium are particularly suitable for this purpose. A not inconsiderable proportion of platinum and rhodium is therefore used in the field of fashion jewellery manufacture. However, the item of jewellery is in this case not made of the solid metal, since this would be much too expensive. Rather, the jewellery base bodies are coated with various noble metals with the aid of various coating processes, e.g. electrolytic surface coating. Such coatings and corresponding coating processes have been described in the prior art for gold, palladium, platinum and rhodium (Hasso Kaiser, Edelmetallschichten in Schriftreihe Galvanotechnik und Oberflächenbehandlung, 2002, 1st edition, Leuze Verlag; Arvid von Krustenstjern, Edelmetallgalvanotechnik, dekorative und technische Anwendungen, 1970, vol. 14, Leuze Verlag).

The deposition of noble metal-containing alloys has been known for some time (DE-A 2429275). This patent application describes an electrolyte which is suitable for depositing rhodium-ruthenium alloys containing at least 90% by weight of rhodium. Rhodium and ruthenium should be present in the electrolyte in a preferred weight ratio of at least 10:1. The layers are said to have a high gloss and lower stresses compared to the layers obtained from rhodium-platinum electrolytes. The proportion of the expensive rhodium in the layers described here is extraordinarily high.

DE-A 2114119 describes a process for the electrolytic deposition of ruthenium alloys with a second metal of the platinum group, in particular rhodium, platinum and palladium. It was found that the appearance and the physical properties and also the corrosion resistance of such layers can be considerably improved by the mixed deposition described. The layers described here contain the noble metal together with a high proportion of ruthenium and optionally further metals selected from the group consisting of osmium and iridium. The layers were deposited on a gold-plated brass specimen.

DE-A 1280014 describes an invention which comprises a process for the electroplating of metals with platinum, palladium, rhodium, ruthenium or alloys of these with one another and/or with iridium. In particular, the baths containing 2.5 g per litre of rhodium and 2.5 g per litre of ruthenium in the electrolyte were used. The electrolytes were used at various temperatures and cathode current densities. Alloys composed of from about 40:60% by weight to 60:40% by weight of ruthenium to rhodium were obtained on the gold coatings used.

It would be desirable to develop noble metal-containing layer sequences which meet decorative requirements, in particular in the fashion jewellery sector. The envisaged layers should come very close in terms of their brightness, colour and colour stability to the pure metal and should have a very high mechanical abrasion resistance and adhesion. Furthermore, it is desirable to be able to keep the price of this “upgrading” as low as possible.

These objects and further objects which are not mentioned in the prior art but can easily be seen by a person skilled in the art are achieved by an article having a particular noble metal-containing layer sequence having the features of the present Claim 1. Preferred embodiments of the article of the invention are defined in the claims dependent on Claim 1. Claims 6 ff. are directed at an appropriately matched process for deposition of the alloys.

Provision of an article for decorative purposes on which a noble metal-containing outer layer sequence comprising, from the inside to the outside, a palladium-containing bottom layer deposited electrochemically or reductively on a metallic substrate and an electrolytically deposited alloy of ruthenium and an element of the group consisting of platinum and rhodium, with the platinum-ruthenium alloy having a platinum content of from about 55 to about 80% by weight and the rhodium-ruthenium alloy having a rhodium content of from about 60 to about 85% by weight, is present, achieves the stated objects in an extremely simple and surprising but nevertheless advantageous manner. The above-described noble metal-containing layer sequence on the decorative articles has, firstly, a surprisingly high brightness which is comparable to the brightness of the pure noble metals. However, completely surprisingly, a significantly improved abrasion resistance compared to the respective pure metals is obtained in the region indicated. These advantages are completed by the fact that the noble metal-containing layer sequences used can be produced more advantageously than those described in the prior art which have pure platinum and/or rhodium layers.

As indicated at the outset, the metallic substrates used for the present invention consist of relatively cheap and non-noble materials. Depending on the deposition process (see below), it can be advantageous in the deposition of the noble metal-containing layer sequence of the invention to coat this with an outer copper layer before the palladium-containing bottom layer is deposited thereon. The shininess, which is very important for jewellery, is improved by a copper layer having a thickness of 5-30 μm, preferably 10-25 μm and very particularly preferably 15-20 μm. Jewellery blanks coming from the foundry are often scratched and have, due to the method of manufacture, a rather rough surface. Although this can be improved by grinding and polishing, only an appropriate layer of copper from a copper electrolyte for deposition of bright copper (LPW-Taschenbuch für Galvanotechnik, 1965, 11th edition, Langbein-Pfannhauser Verlag, Handbuch für Galvanotechnik, 1966, vol. 2, Carl Hanser Verlag) actually leads to the desired smooth and therefore shiny surface. The metallic substrate used therefore advantageously has an outer copper layer onto which the palladium-containing bottom layer is deposited.

The palladium-containing bottom layer forms a corrosion and colour protection for the final layer of the ruthenium alloy which is to be deposited thereon. As indicated below, the latter can be extremely thin. This naturally means that the less noble metals underneath are more easily attacked. To prevent, firstly, the metallic substrates shining through the thin ruthenium alloy layer and, secondly, to prevent penetration of corrosive elements into the metallic substrate to a satisfactory extent, deposition of a palladium layer having a thickness of preferably 0.1-10 μm, preferably 0.5-5 μm and very particularly preferably 1-3 μm, is considered to be sufficient.

The palladium-containing bottom layer is a layer in which the metal palladium is present in a concentration of at least 50% by weight, preferably >60% by weight, more preferably >70% by weight. It is very particularly preferably pure palladium. Such palladium-containing layers are well known to those skilled in the art. The alloying components which may optionally be present are essentially metals from the group consisting of nickel, cobalt, zinc and silver or elements from the group consisting of boron and phosphorus. Such alloys and also their production are, as indicated, known to those skilled in the art (Galvanische Abscheidung von Palladium and Palladium-Legierungen, 1993, DGO reprint, vol. 84).

A final layer of the ruthenium alloy can then be deposited on the palladium. However, it can be advantageous to apply a very thin layer of gold between the palladium and platinum/rhodium-ruthenium layers in order to approve the adhesion of the alloy to the palladium. The gold layer can be deposited by methods known to those skilled in the art (Reid & Goldie, Gold Plating Technology, 1974 Electrochemical Publications LTD.). The deposition of the gold layer is preferably effected in an electroplating bath (Galvanische Abscheidung von Gold, 1998/1999, DGO reprint, vol. 89/90).

Preference is therefore given, according to the invention, for a layer of bonding gold to be present between the palladium-containing bottom layer and the electrolytically deposited alloy. As indicated, the gold layer can be made very thin. It preferably has a thickness of 0.01-0.5 μm, preferably 0.05-0.3 μm and very particularly preferably 0.1-0.2 μm, in order to be able to display the bonding effect.

As indicated above, the final layer of the ruthenium alloy can be extremely thin. Thus, a layer of the ruthenium alloy having a thickness of 0.01-10 μm, preferably 0.05-2 μm and very particularly preferably 0.1-0.5 μm, is considered to be sufficient.

In the range according to the invention, the noble metal-containing layer sequence seen has, firstly, an increased brightness which comes extraordinarily close to that of the pure noble metal. However, it is surprising that such a decorative article is also better protected against abrasion. The abrasion resistance is not only an average value of the abrasion resistances of the two pure metals, but is, contrary to expectations, synergistically improved. In the case of the platinum-ruthenium alloy, the effect according to the invention is particularly advantageous at a platinum content of from about 60 to about 80% by weight, particularly advantageously from about 60 to about 75% by weight. In the case of the rhodium-ruthenium alloy, the rhodium content should be in the range from about 65 to about 80% by weight, particularly advantageously from about 70 to about 80% by weight, in order to bring about the inventive effect in an extraordinarily advantageous way.

In a further part, the present invention provides a process for producing the decorative articles of the invention, which is characterized in that

a) a metallic substrate is reductively or electrochemically coated with a palladium-containing layer;
b) if appropriate, a layer of bonding gold is deposited thereon; and
c) an alloy of ruthenium and an element from the group consisting of platinum and rhodium, with the platinum-ruthenium alloy having a platinum content of from about 55 to about 80% by weight and the rhodium-ruthenium alloy having a rhodium content of from about 60 to about 85% by weight, is electrolytically deposited thereon.

As indicated above, it can be advantageous for the metallic substrate to be coated with a copper layer before step a). In this way, a piece of jewellery, e.g. produced by zinc pressure casting can advantageously firstly be subjected to preliminary copper plating by means of a cyanide-containing copper electrolyte (R. Pinner, Copper and Copper Alloy Plating, 1962, CDA Publication No. 62) and the resulting, usually thin copper layer can subsequently be thickened using an acidic copper electrolyte before being coated further using a palladium electrolyte. In case of zinc pressure castings the preliminary copper plating is necessary since, owing to the low pH of an acidic copper or palladium electrolyte, it is not possible to directly coat the casting. The zinc would simply dissolve. Pieces of jewellery made of brass can, on the other hand, be coated directly using an acidic copper or palladium electrolyte (R. Pinner, Copper and Copper Alloy Plating, 1962, CDA Publication No. 62, Galvanische Abscheidung von Palladium und Palladium-Legierungen, 1993, DGO reprint, vol. 84). Copper plating using an acidic copper electrolyte serves, inter alia, to prepare the surface of the pieces of jewellery for the subsequent steps of coating with noble metals. Insofar as it is possible, a particularly advantageous embodiment is therefore one in which the metallic substrate is (pre)treated with an acidic copper electrolyte. However, if the metallic substrate to be treated is too non-noble, it is advantageously firstly subjected to preliminary copper plating using a cyanide-containing copper electrolyte before any subsequent acidic copper deposition is carried out.

Various methods of depositing the palladium-containing layer on the metallic substrate are known to those skilled in the art (Handbuch für Galvanotechnik, 1966, vol. 2, Carl Hanser Verlag). Deposition of this layer can advantageously be carried out reductively (Rhoda, R. N.: Trans. Inst. Metal Finishing 36, 82/85, 1959) or electrochemically (Galvanische Abscheidung von Palladium und Palladium-Legierungen, 1993, DGO reprint, vol. 84). For the purposes of the invention, electrochemical deposition is deposition which occurs by means of charge exchange (Rhoda R. N.: Barrel Plating by Means of Electroless Palladium, J. Electrochemical Soc. 108, 1961) or electrolytically (Abys J. A.: Plating & Surface Finishing, August 2000). The electrolytic processes differ, inter alia, in the current densities which can be employed. There are essentially 3 different coating processes which may be mentioned.
1. Drum coating for loose material and mass-produced parts:
   In this coating process, rather low working current densities are employed (order of magnitude: 0.05-0.5 A/dm²)
2. Rack coating for individual parts:
   In this coating process, medium working current densities are employed (order of magnitude: 0.2-5 A/dm²)
3. High-speed coating for strips and wires in flow-through plants:
   In this coating region, very high working current densities are employed (order of magnitude: 5-100 A/dm²).

For the purposes of the present invention, rack coating is particularly advantageous for application of the palladium-containing bottom layer and/or the ruthenium alloy.

In an illustrative embodiment, a person skilled in the art will apply the noble metal-containing layer sequence as follows:

Starting from a jewellery blank composed of zinc or a zinc alloy and produced by zinc pressure casting, this is freed of adhering impurities by mechanical removal of flash, grinding and polishing. Zinc is relatively sensitive towards alkalis; and generally no strong alkalis will therefore be used in degreasing and prolonged periods of contact will be avoided. Electrolytic degreasing of the zinc alloys has in the past been carried out exclusively cathodically. Nowadays, there are commercially available means for both cathodic and anodic degreasing; both processes can be employed successfully. As electrolyte, use is made of either phosphate- and/or silicate-containing solutions at elevated temperature or more strongly alkaline solutions at room temperature (Handbuch für Galvanotechnik, 1966, vol. I/2, Carl Hanser Verlag). Degreasing is advantageously carried out using an alkaline, cyanide-containing, cathodically operating cleaner for nonferrous metals (Operating method for degreasing 6030, Umicore Galvanotechnik 2002) using 10 g/l of KCN for 20-40 seconds at 10-15 A/dm². Longer degreasing times are disadvantageous because of the hydrogen absorption and the resulting risk of bubble formation.

After degreasing, normally the articles are dipped into dilute acid to neutralize alkaline residues if electroplating is subsequently to be carried out in an acidic electrolyte. 2-10% strength sulphuric acid or 10-20% strength hydrochloric acid is usually employed as acid. Should a metal deposit be deposited from an alkaline electrolyte after degreasing, the article is dipped beforehand into a solution of about 10% sodium cyanide or potassium cyanide (Handbuch fur Galvanotechnik, 1966, vol. I/2, Carl Hanser Verlag). Since in the present case pieces of jewellery made by zinc pressure casting are coated in an alkaline, cyanide-containing copper electrolyte, a 10% strength KCN solution can advantageously be used for this purpose.

Since a not inconsiderable part of the pickling, degreasing, electroplating and after-treating solutions remains adhering to the workpieces, in the present case the jewellery blanks, on taking out of the baths, a further advantageous step is rinsing in water. Insufficient rinsing can damage both the metal deposits and subsequent electrolytes. A further task of rinsing is to recover the electrolyte residues adhering to the goods. This is especially important in the case of noble metal electrolytes since otherwise large amounts of noble metal can be lost as a result of being carried out (A. v. Krustenstjern, Metalloberfläche 15, 1961). Rinsing is usually carried out in deionized water.

Since the substrate metal used, viz. zinc, is much less noble than copper, a coherent and firmly adhering coating can advantageously be obtained using a cyanide-containing copper electrolyte. In an acid electrolyte, there is a risk of copper being deposited in a loose layer by ion exchange without the influence of an external current and the adhesive strength of the electrochemically applied copper being greatly reduced (Handbuch fur Galvanotechnik, 1966, vol. 2, Carl Hanser Verlag). The basis of all cyanide-containing electrolytes are the complexes which are formed from copper(I) cyanide and sodium cyanide or potassium cyanide on dissolution in water, for example, the cyanide-containing alkaline copper bath 830 (Operating procedure for copper 830, Umicore Galvanotechnik GmbH, 2002), which displays good bright throwing power, excellent metal distribution and extremely rapid coating, is preferably used for preliminary copper plating of the jewellery blanks. This allows the deposition of 5-10 μm layers having good brightness and satisfactory corrosion protection, which is very particularly advantageous in subsequent copper plating in a sulphuric acid electrolyte.

Deposits from acidic copper electrolytes are deposited in layers having a maximum thickness up to about 60 μm in the automobile industry, in the case of household appliances and office machines. In fine mechanics and the electrotechnical industry, deposits of 3-12 μm are generally sufficient to meet the demands made. To be able to meet these many-sided requirements, a large number of copper electrolytes have been developed. Owing to its simple composition and its low price, the sulphuric acid electrolyte is usually employed for the electrolytic deposition of copper from acidic solution. To produce the required total copper layer thickness of 15-20 μm, it is advantageous to use the copper bath 837 by means of which we are able to produce high-gloss, levelling, low porosity and ductile copper layers (Operating procedure for copper 837, Umicore Galvanotechnik GmbH, 2002). Before copper plating in copper 837, it is advantageous, after sufficient flushing operations, to pickle in 2-5% strength sulphuric acid and subsequently to flush sufficiently.

Sufficient flushing is also advisable before further coating with a palladium electrolyte. The corrosion resistance of palladium is relatively good. Palladium has been introduced very widely as a replacement for gold since 1966. The use and expansion of use for these purposes are always closely associated with movements in the price of gold. At high gold prices, the use of Pd is therefore a valuable alternative to gold. This applies both to electrotechnology and to the jewellery and spectacles industry. Recently, palladium is gaining increasing importance as diffusion barrier and as replacement metal for nickel because of the risk of nickel allergy in the case of articles worn close to the skin, e.g. jewellery. The layer thicknesses are up to 4 μm of palladium. Palladium electrolytes require a high purity of the bath constituents since they are very sensitive to impurities. Since palladium electrolytes likewise have to meet demanding requirements (rack, drum or continuous operation), various electrolyte types are needed. On the basis of their pH, a distinction is made between ammoniacal (pH>7) and acidic electrolytes. The ammoniacal electrolytes give off ammonia during operation, and this therefore has to be replaced continually. The higher the pH, the more often is this necessary. Modern electrolytes therefore operate in the pH-range (20° C.) of pH 7-8 (Galvanische Abscheidung von Palladium and Palladium-Legierungen, 1993, DGO reprint, vol. 84). This type includes the advantageous electrolyte palladium 457 (Operating procedure for palladium 457, Umicore Galvanotechnik GmbH, 2006). Palladium 457 is a weakly alkaline palladium electrolyte for decorative and industrial applications. High-gloss and light-coloured pure palladium coatings can be deposited from the electrolyte within a wide current density working range. The white, low porosity coatings are shiny at layer thicknesses up to 5 μm. The ductile layers which have low residual stresses have not only a high hardness and very good wear resistance but also good corrosion and tarnishing resistance. Preference is given to depositing pure palladium layers having a thickness of about 2 μm on the copper-plated pieces of jewellery. The jewellery which is now coated with palladium is subsequently rinsed in deionized water.

Palladium layers are predominantly provided with a gold flash as final coating in order to improve the contact properties in electronic components or to obtain the fashionable colour gold. Even when further layers of platinum group metals, e.g. rhodium or platinum, or alloys thereof are to be deposited onto the palladium, a gold intermediate layer (sandwich structure) is advantageous in order to improve adhesion between the layers. Such a bonding gold layer can, for example, be produced using a nickel- and cobalt-free hard gold electrolyte. The gold electrolyte Auruna 215 (Operating procedure for Auruna 215, Umicore Galvanotechnik, 2002) is a hard gold electrolyte for decorative applications, preferably for parts which come into contact with the skin, e.g. jewellery or watches. The important advantage of the coatings is their freedom from nickel and cobalt, so that skin allergies caused by these metals can be ruled out.

After intensive rinsing in deionized water and subsequent dipping into acid to remove any adhering residues of cyanide from the gold electrolyte, the alloy of ruthenium and an element of the group consisting of platinum and rhodium can be applied as final layer to the bonding gold layer. For this purpose, the gilded substrate is dipped into an electrolyte comprising the alloy metals in an appropriate form and the desired ruthenium-platinum or ruthenium-rhodium alloy is applied to the substrate under the action of electric current of defined magnitude. After subsequent, intensive rinsing (saving rinse for recirculation of noble metal carried out, running rinse with deionized water) and subsequent drying of the coated substrate, the coating process of a blank produced by zinc pressure casting is complete.

When copper and copper alloys are used as substrate, preference has for a long time been given to cathodic degreasing since these metals discolour easily during anodic degreasing (by formation of a film of tarnish) or are even etched a little. Use is frequently made of electrolytes which contain alkali metal cyanides or other complexing agents and prevent formation of oxidic or similar surface films (Handbuch fur Galvanotechnik, 1966, vol. I/2, Carl Hanser Verlag). In the present case, preference is given to carrying out degreasing by means of an alkaline, cyanide-containing, cathodically operating cleaner for nonferrous metals (Operating procedure for degreasing 6030, Umicore Galvanotechnik 2002) containing 10 g/l of KCN for 20-40 seconds at 10-15 A/dm².

After degreasing, the articles are dipped into dilute acid to neutralize residues of alkali if they are subsequently to be electroplated in an acidic electrolyte. It is usual to use 2-10% strength sulphuric acid or 10-20% strength hydrochloric acid as acid. If a metal deposit is to be deposited from an alkaline electrolyte after degreasing, the article is dipped beforehand into a solution of about 10% of sodium cyanide or potassium cyanide. (Handbuch für Galvanotechnik, 1966, vol. I/2, Carl Hanser Verlag). Since in the present case pieces of jewellery made of brass are to be coated in an acidic copper electrolyte, the articles are dipped into a 10% strength sulphuric acid solution.

The further process from copper plating in a sulphuric acid electrolyte proceeds as described above.

As mentioned above, use of the process of the invention gives upgraded articles for decorative purposes which even to the skilled eye appear to be of particularly high quality and display extraordinarily good usability in daily use as a result of the improved abrasion resistance. It should likewise be noted that the use of the significantly cheaper ruthenium in the alloys gives an essential cost advantage which is increased further by a thinner layer compared to the pure noble metal being able to be applied as a result of the improved abrasion resistance. This thinner alloy layer is supported by the use of the underlying palladium-containing bottom layer so that, according to the invention, a uniform brightness and colour of the decorative article and satisfactory resistance to corrosion is obtained. These advantages would not have been expected in the light of the prior art.

In the interests of clarity, it may be stated that the outer layer sequence according to the claims is located on the surface of the metallic substrate. The final alloy layer thus forms the outermost surface of the decorative article.

### FIGURES

FIG. 1 shows the colour curve for a platinum-ruthenium layer. It can be seen that the lightness (measured by the CieLab method; http://www.cielab.de/) is unexpectedly high in the range according to the invention.

FIG. 2 shows the abrasion curve for a platinum-ruthenium alloy. Here, a significantly increased abrasion resistance (measured by the method of Bosch-Weinmann, A. M. Erichsen GmbH, Druckschrift 317/D-V/63, or Weinmann K., Farbe und Lack 65 (1959), pp 647-651) in the range according to the invention can be seen. Since the platinum-ruthenium alloy is accordingly very abrasion resistant, the layer thicknesses previously required when replacing platinum could be significantly reduced, and thus also the costs of carrying out coating.

FIG. 3 shows the colour curve for a rhodium-ruthenium layer. It can be seen that the lightness (measured by the CieLab method; http://www.cielab.de/) is unexpectedly high in the range according to the invention. Although the layer obtained is slightly darker than pure rhodium, the colour differences are perceptible only to the skilled eye and only on direct comparison.

FIG. 4 shows the abrasion resistance of a rhodium-ruthenium alloy (measured by the method of Bosch-Weinmann, A. M. Erichsen GmbH, Druckschrift 317/D-V/63, or Weinmann K., Farbe und Lack 65 (1959), pp. 647-651). The rhodium-ruthenium alloy, too, has become more abrasion resistant by a factor of four by the alloying-in of ruthenium according to the invention, so that a rhodium layer having a thickness of 0.4 μm could theoretically be replaced by a 0.1 μm rhodium-ruthenium layer.

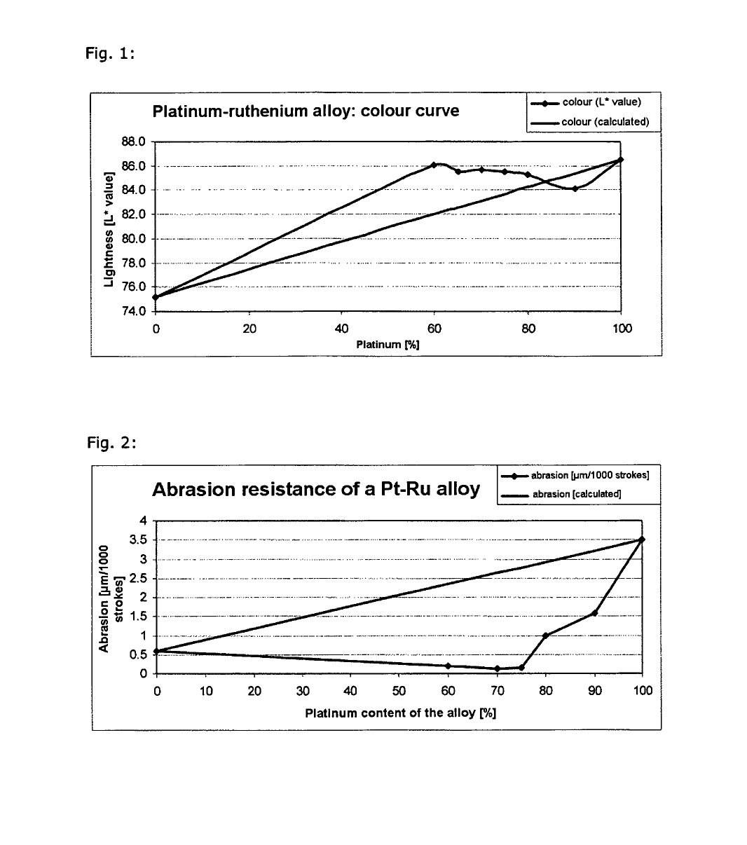

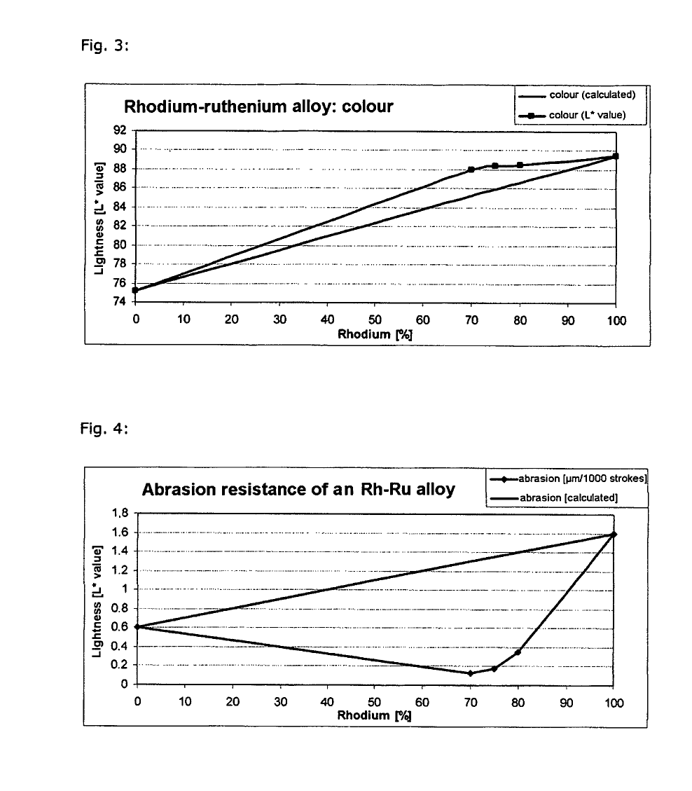

### EXAMPLES

### Example 1

Coating of a jewellery blank made of zinc with a platinum-ruthenium alloy having an alloying ratio of 75:25.

Starting from a jewellery blank made of zinc or a zinc alloy and produced by zinc pressure casting, this was degreased by cathodic degreasing using an alkaline cyanide-containing cleaner for nonferrous metals (Operating procedure for degreasing 6030, Umicore Galvanotechnik 2002) containing 10 g/l of KCN for 20-40 seconds at 10-15 A/dm² and freed of adhering impurities. It was then dipped into a 10% strength KCN solution. To remove the electrolyte residues adhering to the item, it was rinsed in deionized water (saving rinse, flowing rinse). To apply a preliminary copper coating to the jewellery blanks, the alkaline cyanide-containing copper bath 830 (Operating procedure for copper 830, Umicore Galvanotechnik GmbH, 2002) was used. A 5-10 μm layer having good shininess was achieved by means of this. To produce the required total copper layer thickness of 15-20 μm, the copper bath 837 which makes it possible to produce highly shiny, level, low-porosity and ductile copper layers (Operating procedure for copper 837, Umicore Galvanotechnik GmbH, 2002) is used. Before the preliminary copper plating in copper 837, the items have to be, after sufficient rinsing, pickled in 2-5% strength sulphuric acid and subsequently rinsed sufficiently. Adequate rinsing was also ensured before further coating using the palladium electrolyte. According to the operating procedure for palladium 457 (Umicore Galvanotechnik GmbH, 2006), the jewellery blank was treated with a weakly alkaline palladium electrolyte for decorative and industrial applications. About 2 μm thick pure palladium layers were deposited from the electrolyte on the copper-plated pieces of jewellery. The now palladium-coated jewellery was subsequently rinsed in deionized water.

Before the final layer of the ruthenium alloy was deposited, an intermediate gold layer having a thickness of about 0.1-0.2 μm was applied by electroplating to aid adhesion of the layers to one another. The intermediate gold layer was applied to the jewellery blank from the hard gold electrolyte Auruna 215 for decorative applications according to the operating procedure for Auruna 215 (Umicore Galvanotechnik, 2002). After intensive rinsing in deionized water and subsequent dipping into acid in order to remove any adhering residues of cyanide from the gold electrolyte, the alloy of ruthenium and platinum could then be applied as final layer to the bonding gold layer. For this purpose, the gilded substrate was dipped into an electrolyte containing 1.0 g/l of ruthenium and 1.0 g/l of platinum. The desired platinum-ruthenium alloy was deposited on the substrate under the action of electric current of defined current density (1.0 A/dm²). The temperature of the electrolyte was 50° C., and the pH was about 1.0. Platinized titanium anodes were used as anodes. After subsequent, intensive rinsing (saving rinse for recirculation of noble metal carried out, flowing rinse with deionized water) and subsequent drying of the coated substrate, the alloying ratio of the alloy was determined as about 75:25 (platinum:ruthenium) by means of X-ray fluorescence. The colour of the deposited alloy was measured by means of a colour measuring instrument from Xrite by means of which, inter alia, the lightness of a layer can be determined (by the CieLab method; http://www.cielab.de/). The abrasion resistance (measured by the method of Bosch-Weinmann, A. M. Erichsen GmbH, Druckschrift 317/D-V/63, or Weinmann K., Farbe and Lack 65 (1959), pp. 647-651) of the alloy was likewise determined.

### Example 2

Coating of a jewellery blank made of brass with a platinum-ruthenium alloy having an alloying ratio of 60:40

When using copper and copper alloys as starting material for jewellery blanks, degreasing was preferably carried out using an alkaline cyanide-containing, cathodically operating cleaner for nonferrous metals (Operating procedure for degreasing 6030, Umicore Galvanotechnik 2002) containing 10 g/l of KCN for 20-40 seconds at 10-15 A/dm².

After degreasing, the articles are dipped into dilute acid to neutralize residues of alkali when they are subsequently to be electroplated in an acidic electrolyte. Since in the present case pieces of jewellery made of brass are to be coated in an acidic copper electrolyte, they were dipped into a 10% strength sulphuric acid solution.

The further procedure from copper plating in a sulphuric acid electrolyte (Operating procedure for copper 837, Umicore Galvanotechnik GmbH, 2002), palladium coating (Operating procedure for palladium 457, Umicore Galvanotechnik GmbH, 2006) to application of the bonding gold layer (Operating procedure for Auruna 215, Umicore Galvanotechnik, 2002) is carried out as described in Example 1.

After intensive rinsing in deionized water and subsequent dipping into acid to remove any adhering residues of cyanide from the gold electrolyte, the alloy of ruthenium and platinum could be applied as final layer to the bonding gold layer. For this purpose, the gilded substrate was dipped into an electrolyte containing 1.0 g/l of ruthenium and 0.7 g/l of platinum. The desired platinum-ruthenium alloy was deposited on the substrate under the action of electric current of defined current density (1.0 A/dm²). The temperature of the electrolyte was 50° C., and the pH was about 1.0. Platinized titanium anodes were used as anodes. After subsequent, intensive rinsing (saving rinse for recirculation of noble metal carried out, flowing rinse with deionized water) and subsequent drying of the coated substrate, the alloying ratio of the alloy was determined as about 60:40 (platinum:ruthenium) by means of X-ray fluorescence. The colour of the deposited alloy was measured by means of a colour measuring instrument from Xrite by means of which, inter alia, the lightness of a layer can be determined (by the CieLab method; http://www.cielab.de/). The abrasion resistance (measured by the method of Bosch-Weinmann, A. M. Erichsen GmbH, Druckschrift 317/D-V/63, or Weinmann K., Farbe and Lack 65 (1959), pp. 647-651) of the alloy was likewise determined.

### Example 3

Coating of a jewellery blank made of zinc with a rhodium-ruthenium alloy having an alloying ratio of 70:30

Starting from a jewellery blank made of zinc or a zinc alloy and produced by zinc pressure casting, this was, as described in Example 1, degreased by cathodic degreasing using an alkaline cyanide-containing cleaner for nonferrous metals (Operating procedure for degreasing 6030, Umicore Galvanotechnik 2002) and freed of adhering impurities. It was then dipped into a 10% strength KCN solution. To remove the electrolyte residues adhering to the item, it was rinsed in deionized water (saving rinse, flowing rinse). To apply a preliminary copper coating to the jewellery blanks, the alkaline cyanide-containing copper bath 830 (Operating procedure for copper 830, Umicore Galvanotechnik GmbH, 2002) was used again. A 5-10 μm layer having good shininess was achieved by means of this. The further procedure from copper plating in a sulphuric acid electrolyte (Operating procedure for copper 837, Umicore Galvanotechnik GmbH, 2002), palladium coating (Operating procedure for palladium 457, Umicore Galvanotechnik GmbH, 2006) to application of the bonding gold layer (Operating procedure for Auruna 215, Umicore Galvanotechnik, 2002) is carried out as described above in Examples 1 and 2.

After intensive rinsing in deionized water and subsequent dipping into acid to remove any adhering residues of cyanide from the gold electrolyte, the alloy of ruthenium and rhodium could be applied as final layer to the bonding gold layer. For this purpose, the gilded substrate was dipped into an electrolyte containing 0.6 g/l of ruthenium and 1.4 g/l of rhodium. The desired rhodium-ruthenium alloy was deposited on the substrate under the action of electric current of defined current density (2.0 A/dm²). The temperature of the electrolyte was 60° C., and the pH was about 1.0. Platinized titanium anodes were used as anodes. After subsequent, intensive rinsing (saving rinse for recirculation of noble metal carried out, flowing rinse with deionized water) and subsequent drying of the coated substrate, the alloying ratio of the alloy was determined as about 70:30 (rhodium:ruthenium) by means of X-ray fluorescence. The colour of the deposited alloy was measured by means of a colour measuring instrument from Xrite by means of which, inter alia, the lightness of a layer can be determined (by the CieLab method; http://www.cielab.de/). The abrasion resistance (measured by the method of Bosch-Weinmann, A. M. Erichsen GmbH, Druckschrift 317/D-V/63, or Weinmann K., Farbe and Lack 65 (1959), pp. 647-651) of the alloy was likewise determined.

### Example 4

Coating of a jewellery blank made of brass with a rhodium-ruthenium alloy having an alloying ratio of 80:20

When using copper and copper alloys as starting material for jewellery blanks, degreasing was preferably carried out using an alkaline cyanide-containing, cathodically operating cleaner for nonferrous metals (Operating procedure for degreasing 6030, Umicore Galvanotechnik 2002) containing 10 g/l of KCN for 20-40 seconds at 10-15 A/dm².

After degreasing, the articles are dipped into dilute acid to neutralize residues of alkali when they are subsequently to be electroplated in an acidic electrolyte. Since in the present case pieces of jewellery made of brass are to be coated in an acidic copper electrolyte, they were dipped into a 10% strength sulphuric acid solution.

The further procedure from copper plating in a sulphuric acid electrolyte (Operating procedure for copper 837, Umicore Galvanotechnik GmbH, 2002), palladium coating (Operating procedure for palladium 457, Umicore Galvanotechnik GmbH, 2006) to application of the bonding gold layer (Operating procedure for Auruna 215, Umicore Galvanotechnik, 2002) is carried out as described in Example 1.

After intensive rinsing in deionized water and subsequent dipping into acid to remove any adhering residues of cyanide from the gold electrolyte, the alloy of ruthenium and rhodium could be applied as final layer to the bonding gold layer. For this purpose, the gilded substrate was dipped into an electrolyte containing 0.4 g/l of ruthenium and 1.6 g/l of rhodium. The desired rhodium-ruthenium alloy was deposited on the substrate under the action of electric current of defined current density (1.5 A/dm²). The temperature of the electrolyte was 60° C., and the pH was about 1.0. Platinized titanium anodes were used as anodes. After subsequent, intensive rinsing (saving rinse for recirculation of noble metal carried out, flowing rinse with deionized water) and subsequent drying of the coated substrate, the alloying ratio of the alloy was determined as about 80:20 (rhodium:ruthenium) by means of X-ray fluorescence. The colour of the deposited alloy was measured by means of a colour measuring instrument from Xrite by means of which, inter alia, the lightness of a layer can be determined (by the CieLab method; http://www.cielab.de/). The abrasion resistance (measured by the method of Bosch-Weinmann, A. M. Erichsen GmbH, Druckschrift 317/D-V/63, or Weinmann K., Farbe and Lack 65 (1959), pp. 647-651) of the alloy was likewise determined.

1. Article for decorative purposes having a noble metal-containing outer layer sequence comprising, from the inside outwards, a palladium-containing bottom layer deposited electrochemically or reductively on a metallic substrate and an electrolytically deposited alloy of ruthenium and an element from the group consisting of platinum and rhodium, where the platinum-ruthenium alloy has a platinum content of from about 55 to about 80% by weight and the rhodium-ruthenium alloy has a rhodium content of from about 60 to about 85% by weight.

2. Article according to claim 1, wherein
the metallic substrate has an outer copper layer on which the palladium-containing bottom layer is deposited.

3. Article according to claim 1, wherein
a layer of bonding gold is present between the palladium-containing bottom layer and the electrolytically deposited alloy.

4. Article according to, wherein
the platinum-ruthenium alloy has a platinum content of from about 60 to about 75% by weight.

5. Article according to claim 1, wherein
the rhodium-ruthenium alloy has a rhodium content of from about 70 to about 80% by weight.

6. Process for producing a decorative article according to claim 1, wherein
a) a metallic substrate is reductively or electrochemically coated with a palladium-containing layer;
b) if appropriate, a layer of bonding gold is deposited thereon; and
c) an alloy of ruthenium and at least one element from the group consisting of platinum and rhodium, with the platinum-ruthenium alloy having a platinum content of from about 55 to about 80% by weight and the rhodium-ruthenium alloy having a rhodium content of from about 60 to about 85% by weight, is electrolytically deposited thereon.

7. Process according to claim 6, wherein
the metallic substrate is coated with a copper layer before step a).

8. Process according to claim 7, wherein
the metallic substrate is for this purpose treated with an acidic copper electrolyte.

9. Process according to claim 7, wherein
the metallic substrate is for this purpose firstly subjected to preliminary copper plating using a cyanide-containing copper electrolyte.

10. Article according to claim 2, wherein
a layer of bonding gold is present between the palladium-containing bottom layer and the electrolytically deposited alloy.

11. Article according to claim 2, wherein
the platinum-ruthenium alloy has a platinum content of from about 60 to about 75% by weight.

12. Article according to claim 3, wherein
the platinum-ruthenium alloy has a platinum content of from about 60 to about 75% by weight.

13. Article according to claim 2, wherein
the rhodium-ruthenium alloy has a rhodium content of from about 70 to about 80% by weight.

14. Article according to claim 3, wherein
the rhodium-ruthenium alloy has a rhodium content of from about 70 to about 80% by weight.

15. Process according to claim 8, wherein
the metallic substrate is for this purpose firstly subjected to preliminary copper plating using a cyanide-containing copper electrolyte.
